(19) United States
(12) Patent Application Publication
(10) Pub. No.: US 2022/0067845 A1
(43) Pub. Date: Mar. 3, 2022

(54) AGRICULTURAL PRODUCT HANDLING AND STORAGE OPTIMIZATION

(71) Applicant: Kyndryl, Inc., New York, NY (US)

(72) Inventors: Edson GOMES PEREIRA, Sao Paulo (BR); Marcelo MOTO MANHAES, Curitiba (BR); Tiago DIAS GENEROSO, Minas Gerais (BR); Marcel de Toledo PINEDA, Santo Andre (BR); Daniel De Paula TURCO, Sao Paulo (BR); Glaucio Alexandre De AZEVEDO, Sao Paulo (BR)

(21) Appl. No.: 17/001,834

(22) Filed: Aug. 25, 2020

(51) Int. Cl. G06Q 50/02; G06Q 10/04; G06Q 10/06; G06Q 50/28; G06Q 30/02; G06Q 10/10; G06N 20/00; G06N 5/04

(52) U.S. Cl. CPC G06Q 50/02; G06Q 10/04; G06Q 10/067; G06Q 50/28; G06N 5/04; G06Q 10/10; G06Q 10/06375; G06N 20/00; G06Q 30/0201

(57) ABSTRACT

Techniques for agriculture action recommendation are provided. Agricultural information from a plurality of data sources is used to generate a general agriculture data profile and user specific agricultural information is used to generate a user data profile. The general and user specific agricultural information is utilized by an agriculture optimization model to provide an action recommendation and the justification summary for an agriculture product. The action recommendation and the justification summary are based on a plurality of sell and storage options for the at least one agriculture product generated using the agriculture optimization model, where an optimal recommendation is selected by the agriculture optimization model for the agricultural product.

### BACKGROUND

The cultivation and production of agricultural products including crops and livestock, as well as other grown or raised products, is an increasingly complicated and global endeavor. Crops that were previously grown and sold locally or within a short amount of time after harvest may instead enter into a complex agriculture supply chain that is dependent on and affected by global agricultural product markets. The increasing complexity of the agricultural product markets requires agricultural product producers such as farmers, farm managers, and others, to acquire and assess large amounts of information in order to cultivate, harvest, and move agricultural products to market at a profit. One key decision that the producers make is whether to immediately sell products to buyers or to store harvested products for a period of time in order to increase profits for the producer.

While facially a binary choice between selling or storing, storing products introduces many complex factors in the decision making process since storage prices, product prices, and spoliation can all affect the storage of the agricultural products as well as any potential profit from the stored products. Agriculture product producers and decision makers rely on disperse information and decision making processes that cannot account for all of the various factors that may affect the potential profit of the agricultural product once sold. This limited information and ability to routinely accurately predict product outcomes results in producers being exposed to large amounts of risk in the production of agriculture and leaving producers reluctant to expand operations.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method. The method includes receiving agricultural information from a plurality of data sources to generate a general agriculture data profile in an agriculture optimization model, receiving user specific agricultural information may include an agriculture product profile from a user to generate a user data profile in the agriculture optimization model, receiving an agriculture decision request for at least one agriculture product from the user, generating a plurality of agriculture action proposals may include a plurality of sell and storage options for the at least one agriculture product using the agriculture optimization model, determining from the sell and storage options an action recommendation may include a suggested action to take for the at least one product and a justification summary for the suggested action, and providing the action recommendation and the justification summary for the at least one agriculture product to the user. Other embodiments of this aspect include corresponding computer systems, apparatus, and computer programs recorded on one or more computer storage devices, each configured to perform the actions of the methods.

According to another embodiment, a system is provided. The system includes one or more computer processors, and a memory containing a program which when executed by the computer processors performs an operation. The operation may include: receiving agricultural information from a plurality of data sources to generate a general agriculture data profile in an agriculture optimization model, receiving user specific agricultural information may include an agriculture product profile from a user to generate a user data profile in the agriculture optimization model, receiving an agriculture decision request for at least one agriculture product from the user, generating a plurality of agriculture action proposals may include a plurality of sell and storage options for the at least one agriculture product using the agriculture optimization model, determining from the sell and storage options an action recommendation may include a suggested action to take for the at least one product and a justification summary for the suggested action, and providing the action recommendation and the justification summary for the at least one agriculture product to the user. Other embodiments of this aspect include corresponding computer systems, apparatus, and computer programs recorded on one or more computer storage devices, each configured to perform the actions of the methods.

One general aspect includes a computer program product a computer-readable storage medium having computer-readable program code embodied therewith, the computer-readable program code executable by one or more computer processors to perform an operation. The operation may include: receiving agricultural information from a plurality of data sources to generate a general agriculture data profile in an agriculture optimization model, receiving user specific agricultural information may include an agriculture product profile from a user to generate a user data profile in the agriculture optimization model, receiving an agriculture decision request for at least one agriculture product from the user, generating a plurality of agriculture action proposals may include a plurality of sell and storage options for the at least one agriculture product using the agriculture optimization model, determining from the sell and storage options an action recommendation may include a suggested action to take for the at least one product and a justification summary for the suggested action, and providing the action recommendation and the justification summary for the at least one agriculture product to the user.

### BRIEF DESCRIPTION OF THE SEVERAL VIEWS OF THE DRAWINGS

FIG. 1 illustrates an agriculture recommendation system, according to one embodiment.

FIG. 2 illustrates data management components in an agriculture recommendation system, according to one embodiment.

FIG. 3 illustrates a perishability model in an optimization engine, according to one embodiment.

FIG. 4A illustrates a geographic routing model in an optimization engine, according to one embodiment.

FIG. 4B illustrates a routing output of a geographic routing model, according to one embodiment.

FIG. 5 illustrates a storage model in an optimization engine, according to one embodiment.

FIG. 6 illustrates a risk model in an optimization engine, according to one embodiment.

FIG. 7 illustrates a profit model in an optimization engine, according to one embodiment.

FIG. 8 illustrates an action model in an optimization engine, according to one embodiment.

FIG. 9 illustrates a decision tree flowchart for an action recommendation, according to embodiments.

FIG. 10 illustrates a flowchart of a method for an agriculture recommendation, according to embodiments.

FIG. 11 illustrates a block diagram of a system, according to one embodiment.

### DETAILED DESCRIPTION

Agricultural producers (herein producers), including various types of farmers, and others who cultivate plant, crops, livestock, and animal products, manage various parts of the production system for cultivating and supplying agricultural products (herein products) to markets (e.g., customers including consumers, corporate markets, etc.). A key decision in the production and handling of products is whether to move harvested products directly to a market for further use or to store the products. For example, a producer may harvest products and immediately offer the harvested products for sale (e.g., offer the product in a public marketplace or privately etc.) or use the harvested crops (e.g., as animal feed or other product in an agriculture supply chain). Alternatively, the producer may store the harvested product for a period of time (e.g., store the product in storage facilities, etc.). Storing the product may allow the producer to either use the product later or offer the product in the public marketplace when a price for the stored product is higher than at the time of harvest.

When a producer correctly accesses the various factors influencing the price of the product and storage options the producer may see greater income from the product. For example, a decision by a coffee farmer to store harvested coffee when coffee prices are low and sell the coffee out of storage when coffee prices are high, may result in improved profits for the coffee farmer. In another example, a coffee farmer storing coffee when predicting higher prices in the future may experience loss both in the cost of storage and in the lower prices received in the eventual sale of the stored coffee.

As seen in the example with coffee, the producer increases risks that the producer will experience loss associated with the product when deciding to sell or store the product. Storing product also increases the risk that the stored product may spoil, the quality of the product may decrease, or the public market price of the product may decrease before the producer can sell the product. Additionally, storing harvested products incurs some costs including transportation and storage facility costs.

In order to maximize income and minimize losses, the producers weigh the risks and costs associated with storing the product with the potential advantages (including increased profit) of storing the product. These risks and costs are based on a wide range of social, economic, and scientific factors that are often difficult to accurately assess and predict for individual producers. For example, the coffee farmer may harvest coffee beans when coffee prices are low (e.g., due to seasonal price fluctuations, etc.). The coffee farmer may be inclined to store the coffee and wait for coffee prices to increase; however, the producer may not be able to accurately factor in various price forecasts and storage costs that would negate any potential profit from storing the coffee waiting for higher prices. For example, when all other coffee farmers are storing coffee, the price of storage may increase and the future price of coffee may not increase to profitable levels before the stored coffee spoils.

Alternatively, a producer may also not be able to accurately predict much higher potential prices in the future that would induce the producer to products. For example, a coffee farmer may not be able to determine that climate/weather conditions may increase the price of coffee in the future such that storing the coffee for a time may increase the income received in the future.

Currently, producers make these key decisions based on very limited or outdated data leaving the producer working from assumptions that are also outdated or incorrect. In order to minimize risk producers often cautiously make decisions which may result in producers under utilizing various resources available (e.g., arable land, finances, etc.) in order to not expose themselves to potential losses.

While a single producer making un-optimized decisions can affect that producer, producers throughout the world also making their individual decisions based on limited or outdate data and information. This in turn affects a price for the agriculture products as well as the availability and pricing of storage facilities. For example, when a product is routinely not stored, the storage facilities dedicated to the product may be taken off line or devoted to other uses. This may have cascading affects in the future. For example, a lack of storage facilities such as silos can result in products lacking properly storage facilities when needed which in turn affects the selling price. These cascading effects increase volatility in the agriculture market and can lead to decreased motivation of for producers to increase their production since profitable prices or accessible storage is not a guarantee.

Providing producers with accurate models of pricing and storage for products can increase profit for individual producers as well as benefit the agriculture in general since each individual producer will see increased product and profits. Increased profits and process in agriculture often spurs investment and growth in the general economy as well to supply the agriculture industry with new and improved equipment, facilities, etc.

Currently producers can use some limited options for modeling that provide some insight into decisions for whether to store or sell products. These models and systems often rely on limited information such as current product inventory levels of either harvested products or stored products. These models also rely on standard price forecasting without insight into predictive modeling or factoring in the myriad of global level factors that can ultimately affect whether a producer makes a profit for a given product.

The systems and methods described herein provide an optimization engine which recommends and provide support/justifications for various decisions and actions for the producers regarding the amount of product to store or immediately sell. The optimization engine allows producers to make well informed decisions and utilize available resources in order to maximize agriculture production and related incomes.

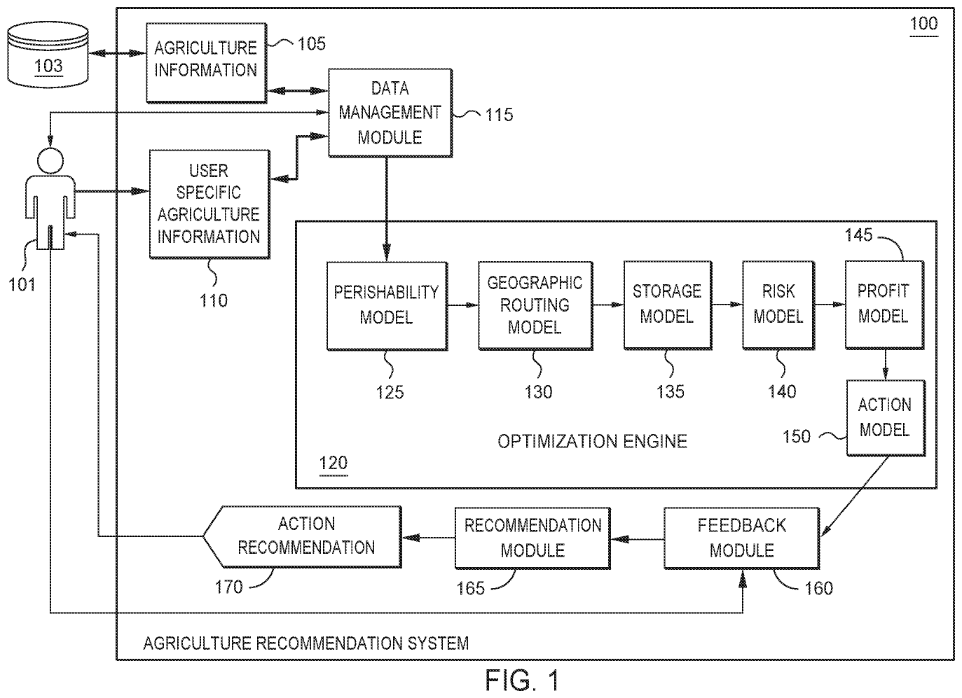

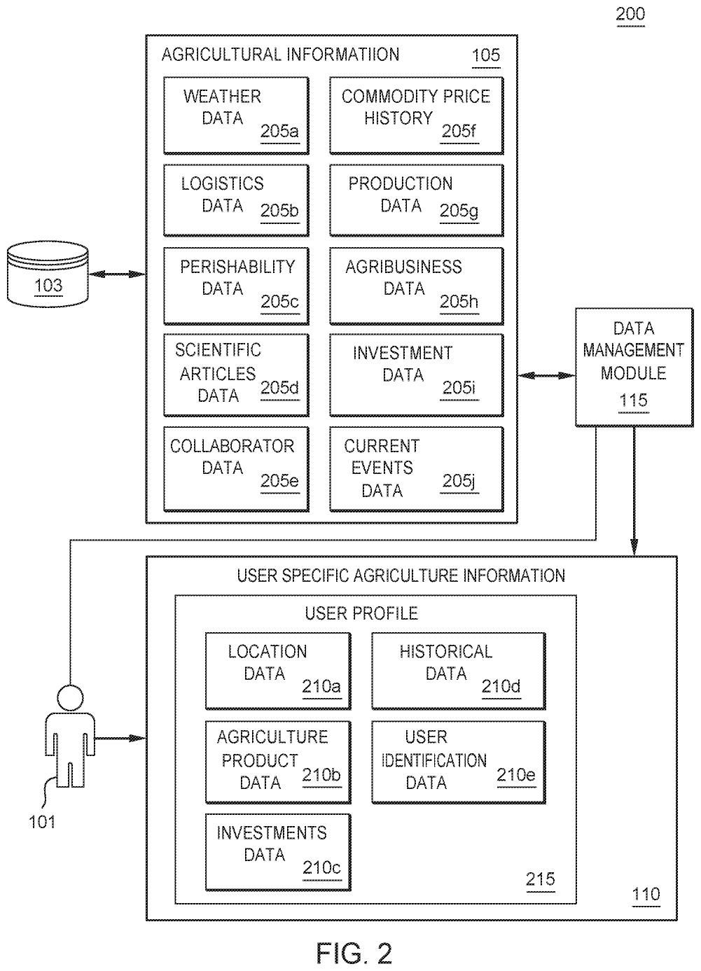

FIG. 1 illustrates an agriculture recommendation system, system 100, according to one embodiment. The system 100 includes a data management module 115, an optimization engine 120, and user interaction modules such as a feedback module 160 and a recommendation module 165. The data management module 115 interacts with various data sources including a database 103 and a user 101 to acquire data and information for use by the system 100. For example, the data management module compiles various general agriculture information such as agriculture information 105 from data sources such as the database 103 and collects user specific agriculture information 110 from the user 101. In some examples, the user 101 interacts with the data management module 115 to collect specific information for either the agriculture information 105 or the user specific agriculture information 110. The data handling components including the data management module 115, the agriculture information 105, and the user specific agriculture information 110 are described in more detail in relation to FIG. 2.

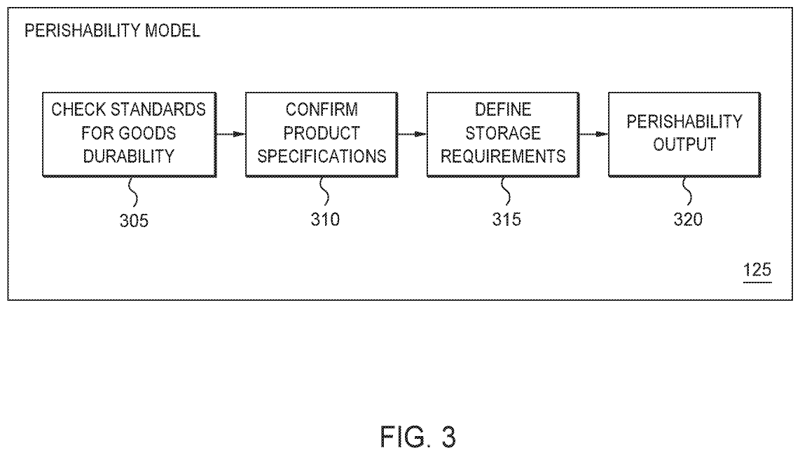

The optimization engine 120 includes various learning models that process information received from the data management module 115 to generate model outputs which enable the system 100 to produce an action recommendation for the user 101. For example, the optimization engine 120 includes a perishability model 125, a geographic routing model 130, a storage model 135, a risk model 140, a profit model 145, and an action model 150. Each of these models are described in greater detail in relation to FIGS. 3-8.

The user interaction modules of system 100 including the feedback module 160 and the recommendation module 165 interaction with the user to adjust the information received from the optimization engine 120 and provide an action recommendation 170 to the user 101. The user 101 may utilize the action recommendation 170 to determine to sell or store an agriculture product.

FIG. 2 illustrates data management components 200 in the agriculture recommendation system, according to one embodiment. The data management components 200 including the data management module 115 collect relevant data in order to provide the optimization engine with information to produce an accurate action recommendation. As discussed in relation to FIG. 1, the agriculture information includes general information gather from various sources such as the database 103. The database 103 may contain a compilation of data sources and/or access to various data sources such as commercial, governmental, non-profit, etc. data sources. The agriculture information 105 acquired or collected from the database 103 include weather data 205a, which may include both short term and long term (climate) conditions and forecasts for geographic areas of interest (e.g., areas where a product is produced, sold, stored, and transported, etc.).

The agriculture information 105 also includes logistics data 205b. The logistics data may include viability studies related to moving and shopping products and provide the optimization engine 120 ability to determine a best method to store or sell a product. The logistics data 205b also includes current storage conditions such as price, quality, and accessibility for storage locations as well as costs associated with transporting and selling the product.

Perishability data 205c includes perishable information/data impacting the use or consumption of products. The perishability data 205c may also define various storage conditions required for a product. Scientific articles data 205d includes any new science or research data or information for that may influence the various other data and data sources.

Collaborator data 205e includes data and other information concerning the producer including a status about the production harvest on his or her property such as product or products, expected Quality/Quantity, etc. This information may be provided by the user 101 or compiled from publicly available resources. Commodity price history 205f includes past a price history of a product and related commodities that may influence a current and future price of a product. Production data 205g includes current and forecasted costs that may influence the current and future production of the product for the user 101.

Agribusiness data 205h includes news or current events in agribusiness that provide context in current and future price and cost trends for the product. Investment data 205i includes information and data related to financial investments into the agriculture field, financial aid or regulations from governments related to agriculture products storage, production, investments etc. Current events data 205j includes data and information related to socio and economic news and events that may affect the agricultural and general economy such as political, economic, and social events that can affect the economy etc. in both a short and long term.

The data management module 115 also compiles data and information for the user 101 in a user profile 215 in the user specific agriculture information 110. The user profile 215 includes location data 210a, agriculture product data 210b, investments data 210c, historical data 210d, and user identification data 210e. The location data 210a includes information related to the geographic location of the producer's facilities, such as crop land, ranch land, and user 101 storage and production facilities. The agriculture product data 210b includes information related to the specific products produced by the user 101 (e.g., product, variety, quality, harvest time, etc.). The historical data 210d includes historical information related to the user 101, such as past production, actions, etc. The user identification data 210e includes information to identify the user 101 as well as other information related to the user 101.

In some examples, the user 101 interacts with the data management module 115 to modify the various sources and compilation of the data in the agriculture information 105 and user specific agriculture information 110. The data management module 115 interacts with the optimization engine 120 to provide data to the various models and update data in the stored information as needed. The optimization engine 120 uses the data from the data management module 115 to build and process the models 125-150 as described in FIGS. 3-9.

FIG. 3 illustrates the perishability model 125 in the optimization engine 120, according to one embodiment. The perishability model 125 generates a perishability output based on a durability of the at least one agriculture product based on standards for the at least one agriculture product in the general agriculture data profile, a product specification for the agriculture product based on the user data profile, and at least one storage requirement for the at least one agriculture product based on the general agriculture data profile and the user data profile

In some examples, the perishability model 125 includes steps 305, 310, and 314 and which output a perishability output 320. The perishability model 125 provides insight into a level of durability for the product. The durability is used in the optimization engine 120 to determine the type and quality of storage needed for the product as well as how long the product may be stored. For example, freshly harvested produce may require chilled storage for a short amount of time while harvested grain may be stored un-chilled for longer periods. The desired quality of the product may also determined. For example, produce that is meant to be sold directly to consumers may require different storage quality than produce provided to corporate consumers (e.g., used in other products, etc.).

In step 305, the perishability model 125 checks standards for goods durability for the product. For example, the optimization engine 120 checks various data sources such as literature and standards information in perishability data 205c and scientific articles data 205d to determine or define the durability of a product in various conditions. At step 310, the perishability model 125 confirms product specifications. For example, the optimization engine 120 verifies a current status for the product (e.g., time of harvest), how the product is currently stored or transported, etc.

At step 315, the perishability model 125 defines storage requirements. For example, the optimization engine 120 checks or verifies requirements to satisfy conditions to store the product for the various times. In some examples, the perishability model 125 generates a perishability output 320 which includes a detailed report including various needs to support producer requirements. In some examples, the perishability output 320 is provided to the geographic routing model 130 and stored for further use, such as use by the action model 150.

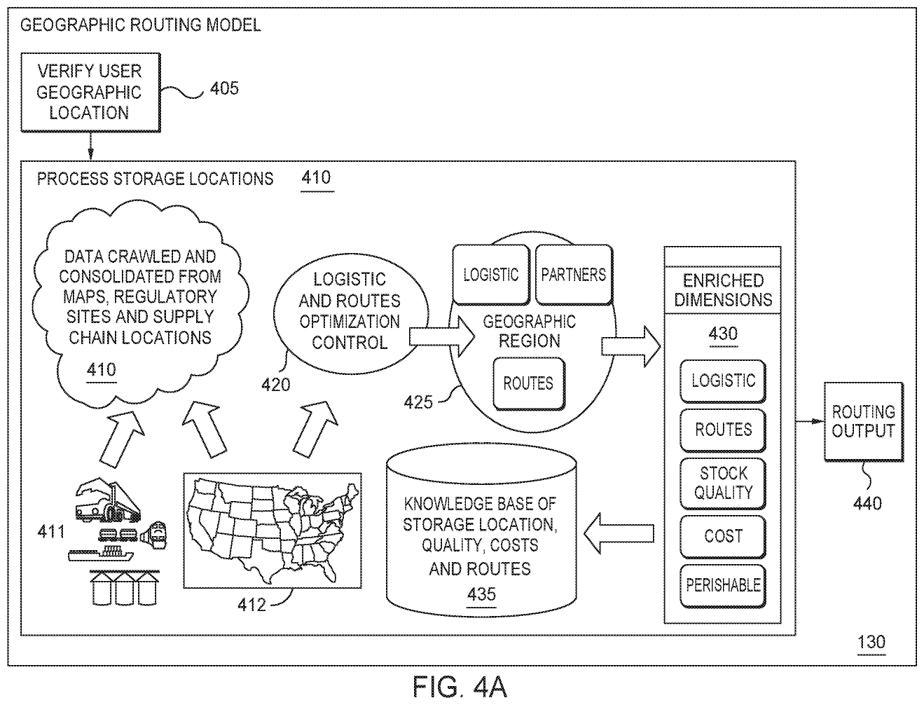

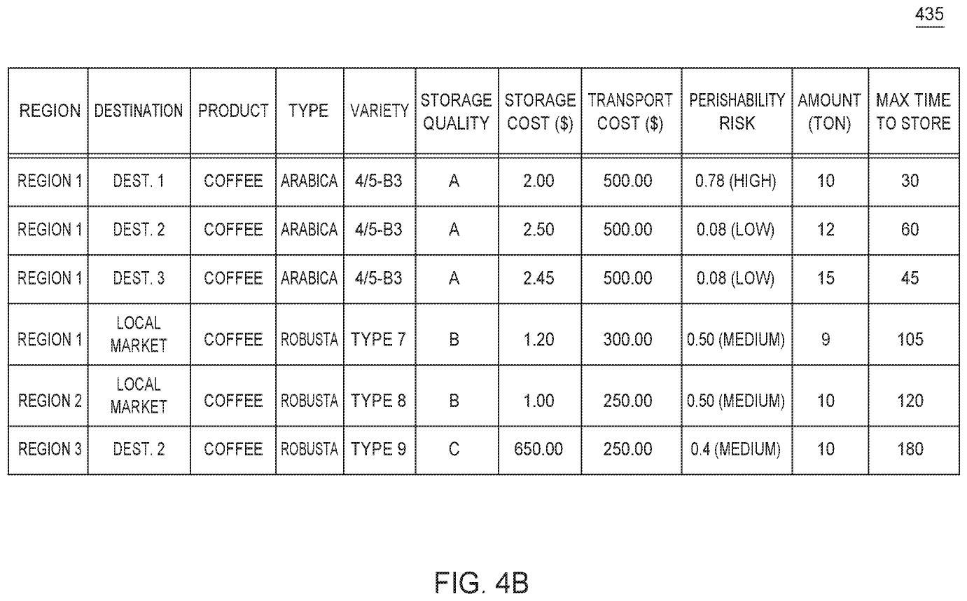

FIG. 4A illustrates the geographic routing model 130 in the optimization engine 120, according to one embodiment. The geographic routing model generates a routing output based on the perishability output, a geographic location provided by a user, a plurality of storage locations, a climate model, and a weather model. The geographic routing model 130 includes steps 405 and 410 to produce a routing output 440. At step 405, the geographic routing model 130 verifies a user geographic location for the user 101. At step 410, the geographic routing model 130 processes various storage facilities and options and validates the various climate conditions and barriers to storage.

In some examples, data model 415 includes data crawled, collected, and consolidated from maps 412 and sites and locations of storage locations 411 which includes data updated on a regular basis for accurate representation in the data model 415. The consolidated data model 415 is processed at Logistic and Routes Optimization control module 420 which process geographic region data 425 to produce enriched dimensions 430 such as logistic information, routing information, storage quality information, transport cost information and perishability information. The geographic routing model 130 utilizes the enriched dimension to build a database 435 which includes a knowledge base storage locations, quality, costs, and routes to the locations as shown in FIG. 4B. As the database 435 is built and completed the geographic routing model 130 outputs a routing output 440 which includes various storage locations and routing options for the agriculture product.

FIG. 4B illustrates a knowledge base or database 435 of a geographic routing model 130, according to one embodiment. The knowledge base or database 435 may include various information for the agriculture product such as region, destination, product, product type, variety, storage quality, storage cost, transport cost, perishability risk, amount of product, and a maximum time to store for a plurality of various products. For example, coffee of a certain type and variety requiring a level storage quality source from a region 1 headed for a destination 1 has associated storage costs, transport costs, and perishability risks. The associated amounts and maximum time for storing of the product. In some examples, the routing output 440 includes a selection of various storage and route options selected from the knowledge base or database 435 and may be provided to a user. In some examples, the routing output 440 is further used by the optimization engine 120 to produce a storage model 135 and is stored for further use such as by the action model 150.

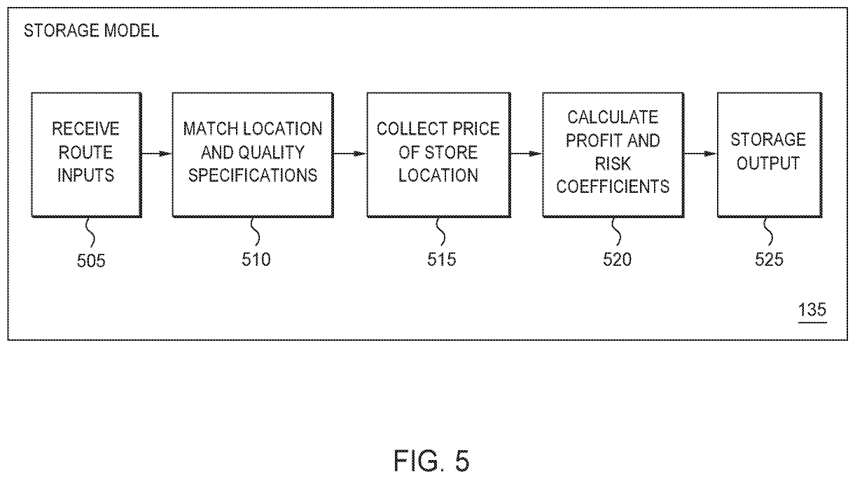

FIG. 5 illustrates a storage model 135 in the optimization engine 120, according to one embodiment. The storage model 135 generates a storage output based on the perishability output, the routing output, and a storage profile for each of the plurality of storage locations. The storage output includes at least a report comprising a plurality of storage options and associated risk calculation for the at least one storage option. The storage model 135 includes steps 505-520 to produce a storage output 525

At step 505, the storage model 135 receives route inputs such as the routing output 440 and/or the knowledge base or database 435 which may include various routes and associated costs for storing an agriculture product. At step 510, the storage model 135 matches a storage location and product quality based on input from the producer, time of harvest for the product, perishable coefficient from the routing output 440, and other information for the product (e.g., type of culture). At step 515, the storage model 135 captures a price of store locations based on the routing output and the agriculture information 105 and calculates product and risk coefficients for each storage location at step 520. The storage model narrows the storage options based on the product and risk coefficients and outputs each viable and/or valid location as the storage output 525.

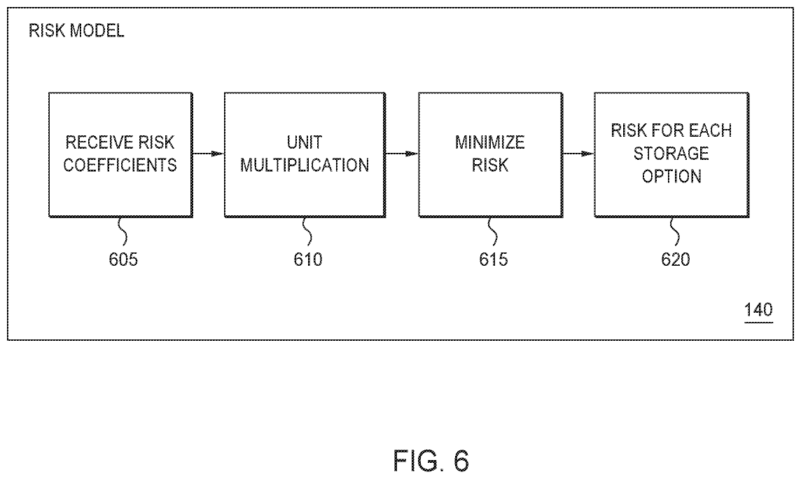

FIG. 6 illustrates the risk model 140 in the optimization engine 120, according to one embodiment. The risk model 140 generates a risk output based on the associated risk calculation, a risk selection in the user data profile, and a risk optimization function. The model includes steps 605-615 to produce a risk output 620.

At step 605, the risk model 140 receives risk coefficients from the storage model (e.g., from the storage output 525). At step 610, the risk model 140 executes multiplications of each combination coefficient from the storage output 525. For example, using 1 and 0 of location A, B, C where 1 is the location selected and 0 if was not selected on combination and applying a regression model. At step 615, the risk model 140 executes a minimize risk optimization by sorting and selecting lower risk options for further processing and report each risk for each possible combination in the risk output 620.

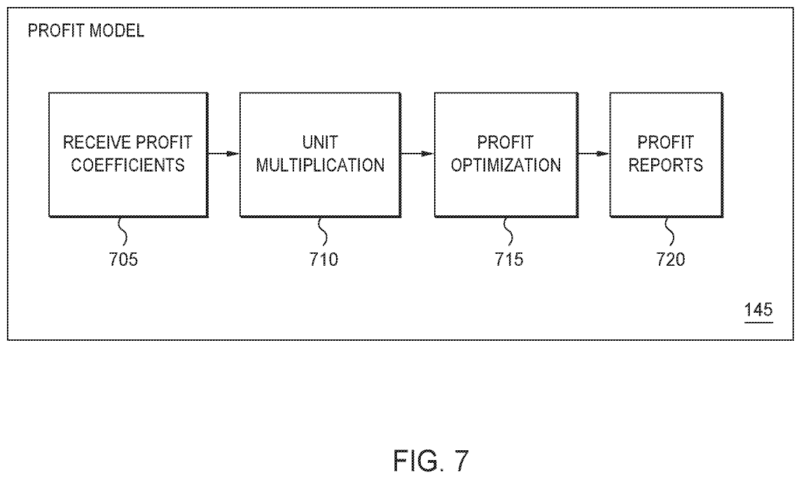

FIG. 7 illustrates the profit model 145 in the optimization engine 120, according to one embodiment. The profit model 145 generates a profit report output including a profit estimation based on a risk for each storage options, a profit coefficient received from the user, and a profit optimization function. The model includes steps 705-715 to produce a profit output such as profit reports 720.

At step 705, the profit model 145 receives profit coefficients from the risk model 140 for the various storage options. At step 710, the profit model 145 executes multiplications coefficient such as multiplying a loss ratio by a projected price for location combinations. At step 715, the profit model 145 executes a profit optimization function where options with a higher determined profit is selected for profit reports 720 which includes a predicted profit based on trained calculations that will deliver the suggested price of a product based on political conditions, political, social concerns and perishable coefficients.

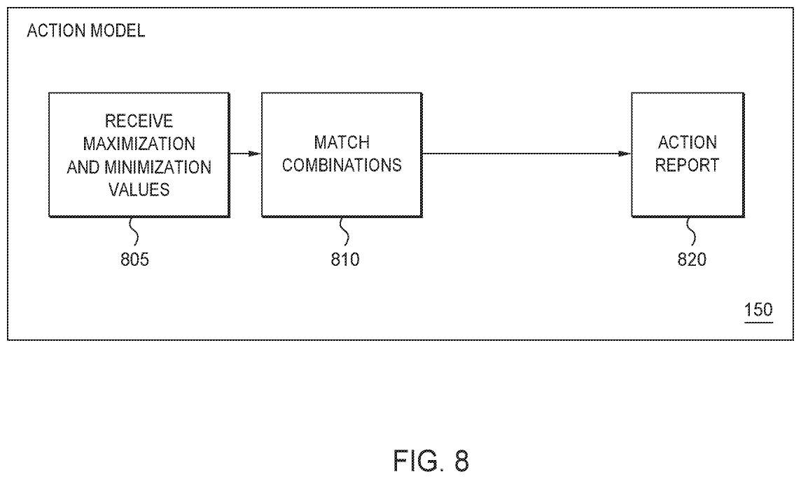

FIG. 8 illustrates an action model 150 in the optimization engine 120, according to one embodiment. This optimization model uses the outputs from each of the models of the optimization engine 120 to determine possible routes to deliver the products and what storage options will be available in the way to choose the proper action to take for the product. The action model 150 receives maximization and minimization values from risk and profit calculations and other data about perishable, routes and stock options from the risk model 140, the storage model 135, and the data management module 115. At step 810 the action model matches combinations of various options. The action model may utilize Answer Justifying Documents (AJDs) including unstructured content that is crawled, transformed and enriched in data preparation phase by the data management module 115 The AJDs are indexed information that will be used to complement the decisions provided by Match Combination at step 810.

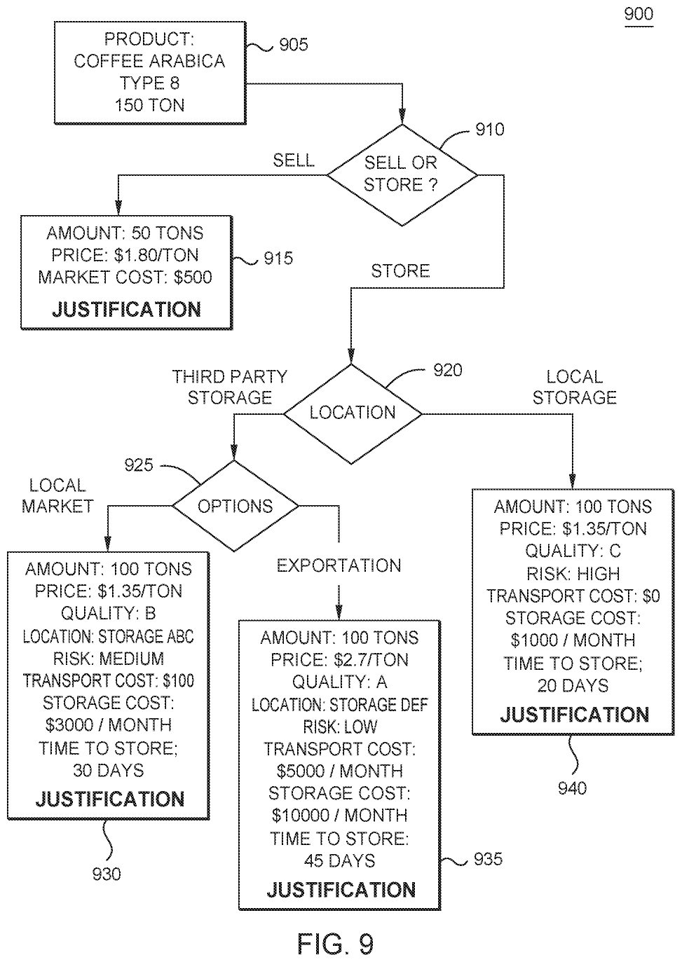

In some examples, the match combinations use a classification of risk with high medium and low risk classifications. The action report 820 includes possible outcomes based on the risk classifications. For example, a possible outcome may show a producer all the alternatives with profit and risk associated. For example, the action report 820 may include a decision tree such as decision tree 900 described in FIG. 9 with all feasible combinations (above a threshold).

FIG. 9 illustrates a decision tree 900 for an action recommendation, according to embodiments. The decision tree 900 includes the input 905 which is a request for action for the product (e.g., 150 tons of Coffee Arabica type 8). The decision 910 includes a decision to sell or store the product. A sell option 915 includes a suggested sale amount, price, and associated cost along with a justification for the option 915. The justification is based on the AJDs that are unstructured documents indexed to match the decisions. The store option includes options 930 935 and 940 which each include associated storage options, quality, costs, etc. based on the optimization engine 120 and justifications for each of the displayed options. For example, local or third party storage is differentiated at location decision 920 and local market or exportation is differentiated at storage option decision 925. In some examples, the action report includes a determination of the best options to maximize profit. For example, the decision tree 900 includes a highlight of option 915 and 935 as the suggested sell/storage options for the product.

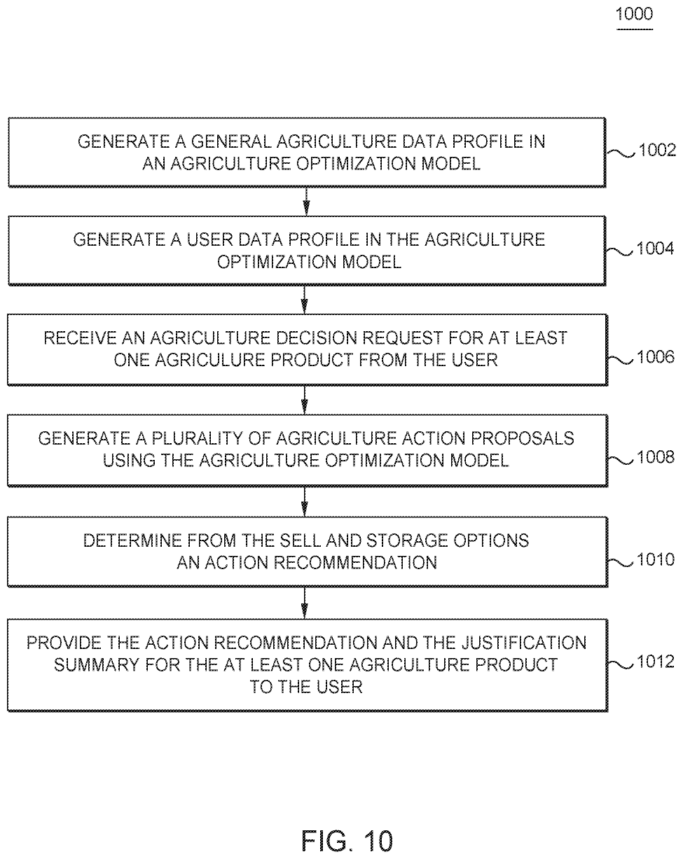

FIG. 10 illustrates a flowchart of a method 1000 for an agriculture recommendation, according to embodiments. The method 1000 begins at block 1002 where the system 100 receives agricultural information from a plurality of data sources to generate a general agriculture data profile in an agriculture optimization model such as the agricultural information 105.

At block 1004 the system 100 receives user specific agricultural information comprising an agriculture product profile from a user to generate a user data profile in the agriculture optimization model such as the user specific agriculture information.

At block 1006, the system 100 receives an agriculture decision request for at least one agriculture product from the user. At block 1008, the system 100 generates a plurality of agriculture action proposals comprising a plurality of sell and storage options for the at least one agriculture product using the agriculture optimization model.

At block 1010, the system 100 determines from the sell and storage options an action recommendation comprising a suggested action to take for the at least one product and a justification summary for the suggested action. At block 1012, the system 100 provides the action recommendation and the justification summary for the at least one agriculture product to the user.

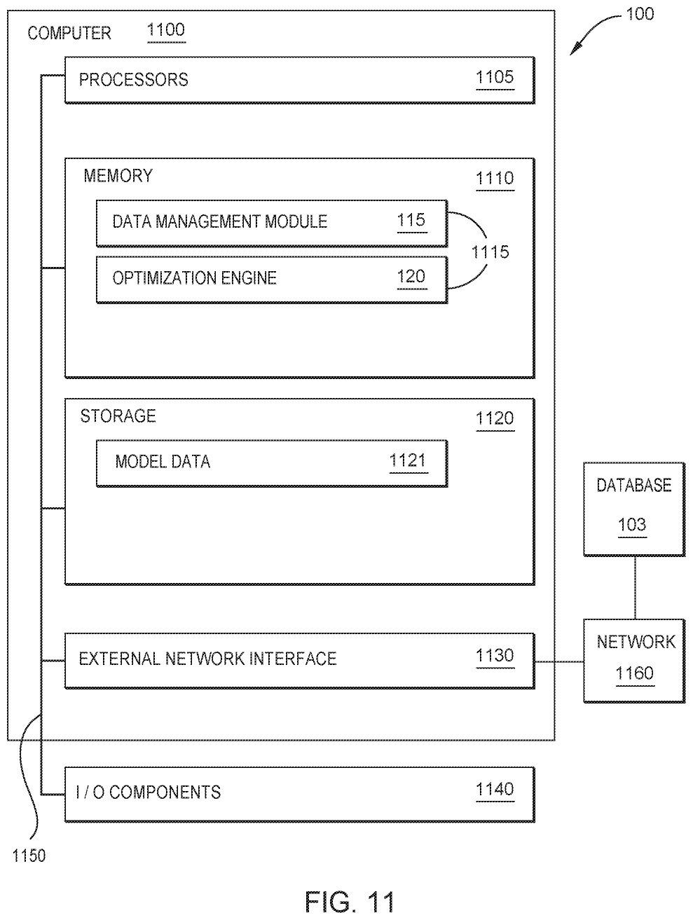

FIG. 11 illustrates a block diagram of a system 100, according to one embodiment. The system 100 is shown in the form of a general-purpose computing device, computer 1100. The components of the computer 1100 may include, but are not limited to, one or more processing units or processors 1105, a memory 1110, a storage system 1120, network interface 1130, and a bus 1150 that couples various system components including the memory 1110 and storage system 1120 to processors 1105 along with various input/output (I/O) components 1140. In other embodiments, system 100 is distributed and includes a plurality of discrete computing devices that are connected through wired or wireless networking.

Bus 1150 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer 1100 typically includes a variety of computer system readable media. Such media may be any available media that is accessible by computer 1100, and it includes both volatile and non-volatile media, removable and non-removable media. Memory 1110 can include computer system readable media in the form of volatile memory, such as random access memory (RAM) and/or cache memory. Computer 1100 may further include other removable/non-removable, volatile/non-volatile computer system storage media. By way of example, storage system 1120 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1150 by one or more data media interfaces. As will be further depicted and described below, memory 1110 may include at least one program product having a set (e.g., at least one) of program modules that are configured to carry out the functions of embodiments of this disclosure.

Computer 1100 may further include other removable/non-removable, volatile/non-volatile computer system storage media. In some examples, storage system 1120 may be included as part of memory 1110 and may typically provide a non-volatile memory for the networked computing devices, and may include one or more different storage elements such as Flash memory, a hard disk drive, a solid state drive, an optical storage device, and/or a magnetic storage device. For example, storage system 1120 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1150 by one or more data media interfaces. Storage system 1120 may include media for storing model data 1121 including data received in the data handled by the data management module 115 and produced by the optimization engine 120. The storage system 1120 may be updated and accessed by program modules 1115 described herein.

Memory 1110 may include a plurality of program modules 1115 for performing various functions described herein. The program modules 1115 generally include program code that is executable by one or more of the processors 1105. As shown, program modules 1115 include data management module 115 and the optimization engine 120.

Computer 1100 may also communicate with one or more external devices user, providing a user interface, such as a keyboard, a pointing device, a display, etc.; and one or more devices that enable a user to such as interact with computer 1100; and/or any devices (e.g., network card, modem, etc.) that enable computer 1100 to communicate with one or more other computing devices. Such communication can occur via I/O components 1140. Additionally, computer 1100 may communicate with one or more external databased and networks such as a local area network (LAN), a general wide area network (WAN), and/or a public network (e.g., the Internet) via network interface 1130. As depicted, network interface 1130 communicates with the other components of computer 1100 via bus 1150. It should be understood that although not shown, other hardware and/or software components could be used in conjunction with computer 1100. Examples, include, but are not limited to: cloud computing systems, microcode, device drivers, redundant processing units, external disk drive arrays, RAID systems, tape drives, and data archival storage systems, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications or related data available in the cloud.

While the foregoing is directed to embodiments of the present invention, other and further embodiments of the invention may be devised without departing from the basic scope thereof, and the scope thereof is determined by the claims that follow.

1. A method comprising:
receiving agricultural information from a plurality of data sources to generate a general agriculture data profile in an agriculture optimization model;
receiving user specific agricultural information comprising an agriculture product profile from a user to generate a user data profile in the agriculture optimization model;
receiving an agriculture decision request for at least one agriculture product from the user;
generating, using optimization control module, a plurality of enriched dimensions comprising at least logistic information, routing information, and storage quality information for the at least one agriculture product in the agriculture optimization model;
generating a knowledge base for the agriculture product using the enriched dimensions;
updating, using the optimization control module, the plurality of enriched dimensions and the knowledge base for the at least one agriculture product based on additional data collected from the plurality of data sources;
generating a plurality of agriculture action proposals comprising a plurality of sell and storage options for the at least one agriculture product using the knowledge base of the agriculture optimization model;
determining from the sell and storage options an action recommendation comprising a suggested action to take for the at least one agriculture product and a justification summary for the suggested action; and
providing the action recommendation and the justification summary for the at least one agriculture product to the user.

2. The method of claim 1, wherein the optimization model comprises a plurality of learning models wherein each of the plurality of learning models generates one model output of a plurality of generated model outputs based on the user data profile associated and the general agriculture data profile, wherein the plurality of learning models comprises at least one of:
a perishability model;
a geographic routing model;
a storage model;
a risk model;
a profit model; and
an action model; and
wherein the plurality of agriculture action proposals are generated using the plurality of generated model outputs.

3. The method of claim 2, wherein the perishability model generates a perishability output based on:
a durability of the at least one agriculture product based on standards for the at least one agriculture product in the general agriculture data profile;
a product specification for the agriculture product based on the user data profile; and
at least one storage requirement for the at least one agriculture product based on the general agriculture data profile and the user data profile; and
wherein the perishability output comprises at least a report on the durability for the at least one agriculture product.

4. The method of claim 3, wherein the geographic routing model generates a routing output based on:
the perishability output;
a geographic location provided by a user;
a plurality of storage locations;
a climate model;
a weather model; and
wherein the routing output comprises at least a report comprising at least one route and storage option for the at least one agriculture product.

5. The method of claim 4, wherein the storage model generates a storage output based on:
the perishability output;
the routing output; and
a storage profile for each of the plurality of storage locations; and
wherein the storage output comprises at least a report comprising a plurality of storage options and associated risk calculation for the at least one storage option.

6. The method of claim 5, wherein the risk model generates a risk output based on:
the associated risk calculation;
a risk selection in the user data profile; and
a risk optimization function; and
wherein the risk output comprises at least a risk coefficient for each of the storage options.

7. The method of claim 6, wherein the profit model generates a profit report output based on:
a risk for each storage options;
a profit coefficient received from the user; and
a profit optimization function; and
wherein the profit report output comprises at least a profit estimation for each of the storage options.

8. The method of claim 7, wherein the action model generates an action report based on:
the plurality of model outputs; and
wherein the action report comprises the plurality of agriculture action proposals.

9. A system comprising:
one or more computer processors; and
a memory containing a program which when executed by the computer processors performs an operation comprising:
receiving agricultural information from a plurality of data sources to generate a general agriculture data profile in an agriculture optimization model;
receiving user specific agricultural information comprising an agriculture product profile from a user to generate a user data profile in the agriculture optimization model;
receiving an agriculture decision request for at least one agriculture product from the user;
generating, using optimization control module, a plurality of enriched dimensions comprising at least logistic information, routing information, and storage quality information for the at least one agriculture product in the agriculture optimization model;
generating a knowledge base for the agriculture product using the enriched dimensions;
updating, using the optimization control module, the plurality of enriched dimensions and the knowledge base for the at least one agriculture product based on additional data collected from the plurality of data sources;
generating a plurality of agriculture action proposals comprising a plurality of sell and storage options for the at least one agriculture product using the knowledge base of the agriculture optimization model;
determining from the sell and storage options an action recommendation comprising a suggested action to take for the at least one agriculture product and a justification summary for the suggested action; and
providing the action recommendation and the justification summary for the at least one agriculture product to the user.

10. The system of claim 9, wherein the optimization model comprises a plurality of learning models wherein each of the plurality of learning models generates one model output of a plurality of generated model outputs based on the user data profile associated and the general agriculture data profile, wherein the plurality of learning models comprises at least one of:
a perishability model;
a geographic routing model;
a storage model;
a risk model;
a profit model; and
an action model; and
wherein the plurality of plurality of agriculture action proposals are generated using the plurality of generated model outputs.

11. The system of claim 10, wherein the perishability model generates a perishability output based on:
a durability of the at least one agriculture product based on standards for the at least one agriculture product in the general agriculture data profile;
a product specification for the agriculture product based on the user data profile; and
at least one storage requirement for the at least one agriculture product based on the general agriculture data profile and the user data profile; and
wherein the perishability output comprises at least a report on the durability for the at least one agriculture product.

12. The system of claim 11, wherein the geographic routing model generates a routing output based on:
the perishability output;
a geographic location provided by a user;
a plurality of storage locations;
a climate model;
a weather model; and
wherein the routing output comprises at least a report comprising at least one route and storage option for the at least one agriculture product.

13. The system of claim 12, wherein the storage model generates a storage output based on:
the perishability output;
the routing output; and
a storage profile for each of the plurality of storage locations; and
wherein the storage output comprises at least a report comprising a plurality of storage options and associated risk calculation for the at least one storage option.

14. The system of claim 13, wherein the risk model generates a risk output based on:
the associated risk calculation;
a risk selection in the user data profile; and
a risk optimization function; and
wherein the risk output comprises at least a risk coefficient for each of the storage options.

15. The system of claim 14, wherein the profit model generates a profit report output based on:
a risk for each storage options;
a profit coefficient received from the user; and
a profit optimization function; and
wherein the profit report output comprises at least a profit estimation for each of the storage options;
wherein the action model generates an action report based on:
the plurality of model outputs; and
wherein the action report comprises the plurality of plurality of agriculture action proposals.

16. A computer program product, the computer program product comprising:
a non-transitory computer-readable storage medium having computer-readable program code embodied therewith, the computer-readable program code executable by one or more computer processors to perform an operation, the operation comprising:
receiving agricultural information from a plurality of data sources to generate a general agriculture data profile in an agriculture optimization model;
receiving user specific agricultural information comprising an agriculture product profile from a user to generate a user data profile in the agriculture optimization model;
receiving an agriculture decision request for at least one agriculture product from the user;
generating, using optimization control module, a plurality of enriched dimensions comprising at least logistic information, routing information, and storage quality information for the at least one agriculture product in the agriculture optimization model;
generating a knowledge base for the agriculture product using the enriched dimensions;
updating, using the optimization control module, the plurality of enriched dimensions and the knowledge base for the at least one agriculture product based on additional data collected from the plurality of data sources;
generating a plurality of agriculture action proposals comprising a plurality of sell and storage options for the at least one agriculture product using the knowledge base of the agriculture optimization model;
determining from the sell and storage options an action recommendation comprising a suggested action to take for the at least one agriculture product and a justification summary for the suggested action; and
providing the action recommendation and the justification summary for the at least one agriculture product to the user.

17. The computer program product of claim 16, wherein the optimization model comprises a plurality of learning models wherein each of the plurality of learning models generates one model output of a plurality of generated model outputs based on the user data profile associated and the general agriculture data profile, wherein the plurality of learning models comprises at least one of:
a perishability model;
a geographic routing model;
a storage model;
a risk model;
a profit model; and
an action model; and
wherein the plurality of agriculture action proposals are generated using the plurality of generated model outputs.

18. The computer program product of claim 17, wherein the perishability model generates a perishability output based on:
a durability of the at least one agriculture product based on standards for the at least one agriculture product in the general agriculture data profile;
a product specification for the agriculture product based on the user data profile; and
at least one storage requirement for the at least one agriculture product based on the general agriculture data profile and the user data profile; and
wherein the perishability output comprises at least a report on the durability for the at least one agriculture product.

19. The computer program product of claim 18, wherein the geographic routing model generates a routing output based on:
the perishability output;
a geographic location provided by a user;
a plurality of storage locations;
a climate model;
a weather model; and
wherein the routing output comprises at least a report comprising at least one route and storage option for the at least one agriculture product.

20. The computer program product of claim 19, wherein the storage model generates a storage output based on:
the perishability output;
the routing output; and
a storage profile for each of the plurality of storage locations; and
wherein the storage output comprises at least a report comprising a plurality of storage options and associated risk calculation for the at least one storage option.
